(19) United States
(12) Patent Application Publication
(10) Pub. No.: US 2013/0309085 A1
(43) Pub. Date: Nov. 21, 2013

(54) COMPRESSOR CASE OVERHAUL

(71) Applicants: Daniel Paul Panayil, San Diego, CA (US); Thomas Lee Eddy, Stateline, NV (US); Gerardo Zozula, San Diego, CA (US); Carlos Alberto Cortes Serrano, San Ysidro, CA (US)

(72) Inventors: Daniel Paul Panayil, San Diego, CA (US); Thomas Lee Eddy, Stateline, NV (US); Gerardo Zozula, San Diego, CA (US); Carlos Alberto Cortes Serrano, San Ysidro, CA (US)

(73) Assignee: Solar Turbines Incorporated, San Diego, CA (US)

(21) Appl. No.: 13/472,290

(22) Filed: May 15, 2012

(51) Int. Cl. F04D 29/40; B23P 6/00

(52) U.S. Cl. 415/214.1; 29/888.021

(57) ABSTRACT

A longitudinally-split compressor case of a gas turbine engine is overhauled to inhibit leakage between case segments that have been distorted. Grooves are machined in mating surfaces of the case segments. Seal wires are located at the grooves.

### TECHNICAL FIELD

The present disclosure generally pertains to gas turbine engines and more particularly to methods for overhaul of compressor cases of gas turbine engines.

### BACKGROUND

Gas turbine engines include compressor, combustor, and turbine sections. Internal components of the compressor section are housed in a compressor case that is generally cylindrical. For ease of manufacturing, the compressor case is commonly a split case. The split case has two halves that are joined on an axial plane. A solid seal at the joint between the two halves of the compressor case is desired so that compressed gases do not escape from the compressor section. The joint between the two halves of the compressor case is subjected to large thermal and mechanical stresses during operation of the gas turbine. The stress may distort the compressor case and compromise the seal between he two halves of the compressor case.

Vedantam et al., in U.S. Pat. No. 6,655,913, describe a composite seal for installation in a compressor case having mating margins machined to a flat surface with a high tolerance. The composite seal has an inner woven metal core surrounded by an annular silica fiber layer, in turn surrounded by a metal foil with an outer protective covering of a braided stainless steel

### SUMMARY OF THE DISCLOSURE

A method for overhaul of a longitudinally-split compressor case is provided. The compressor case includes two case segments. Each of the case segments has a half-barrel section and mating surfaces at the longitudinal margins of the half-barrel section. The case segments are joined at corresponding pairs of the mating surfaces. The method includes: machining longitudinal grooves into the mating surfaces of a first one of the case segments; locating seal wires at the grooves; and reassembling the compressor case.

A compressor case for a gas turbine engine includes a first case segment and a second case segment. The first case segment includes a half-barrel section, mating surfaces at the longitudinal margins of the half-barrel section, and grooves disposed longitudinally in the mating surfaces. The grooves are formed during an overhaul of the compressor case. The second case segment includes a half-barrel section and mating surfaces at the longitudinal margins of the half-barrel section. The first case segment and the second case segment are joined at corresponding pairs of the mating surfaces. Seal wires disposed at the grooves.

### BRIEF DESCRIPTION OF THE DRAWINGS

FIG. 1 is a schematic illustration of an exemplary gas turbine engine.

FIG. 2 is an exploded view of aspects of an exemplary compressor case according to an exemplary disclosed embodiment.

FIG. 3 is an assembled view of the exemplary compressor case of FIG. 2.

FIG. 4 is an end view of an area of the exemplary compressor case of FIGS. 1 and 2.

FIG. 5 is a flowchart of a process for overhaul of compressor cases according to an exemplary disclosed embodiment.

### DETAILED DESCRIPTION

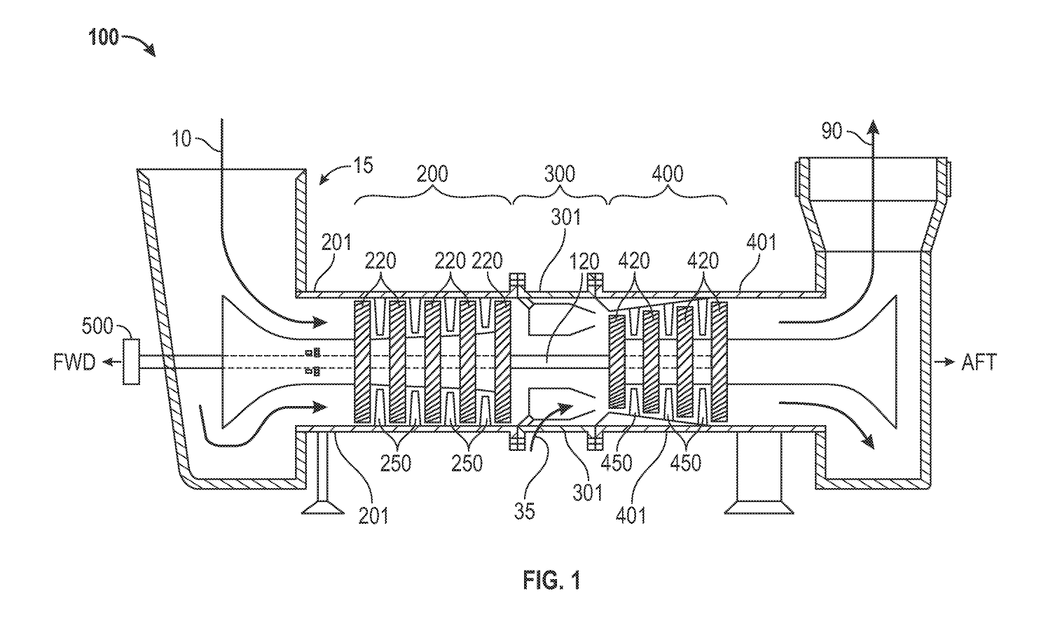

FIG. 1 is a schematic illustration of an exemplary gas turbine engine. A gas turbine engine 100 typically includes a compressor 200, a combustor 300, and a turbine 400. Air 10 enters an inlet 15 as a “working fluid” and is compressed by the compressor 200. Fuel 35 is added to the compressed air in the combustor 300 and then ignited. Energy is extracted from the combusted fuel/air mixture via the turbine 400 and is typically made usable via a power output coupling 500. The power output coupling 500 is shown as being on the forward side of the gas turbine engine 100, but in other configurations it may be provided at the aft end of gas turbine engine 100. Exhaust 90 may exit the system or be further processed (e.g., to reduce harmful emissions or to recover heat from the exhaust).

The compressor 200 includes one or more compressor rotor assemblies 220 mechanically coupled to a shaft 120. The turbine 400 includes one or more turbine rotor assemblies 420 mechanically coupled to the shaft 120. As illustrated, the compressor rotor assemblies 220 and the turbine rotor assemblies 420 are axial flow rotor assemblies, where each rotor assembly includes a rotor disk that is circumferentially populated with a plurality of airfoils (“rotor blades”).

Compressor stationary vanes (“stator vanes” or “stators”) 250 axially separate the rotor blades associated with adjacent compressor rotor assemblies 220. Turbine stationary vanes 450 axially separate the rotor blades associated with adjacent turbine rotor assemblies 420.

The various components of the compressor 200 are housed in a compressor case 201 that is generally cylindrical. The various components of the combustor 300 and the turbine 400 are housed, respectively, in a combustor case 301 and a turbine case 401.

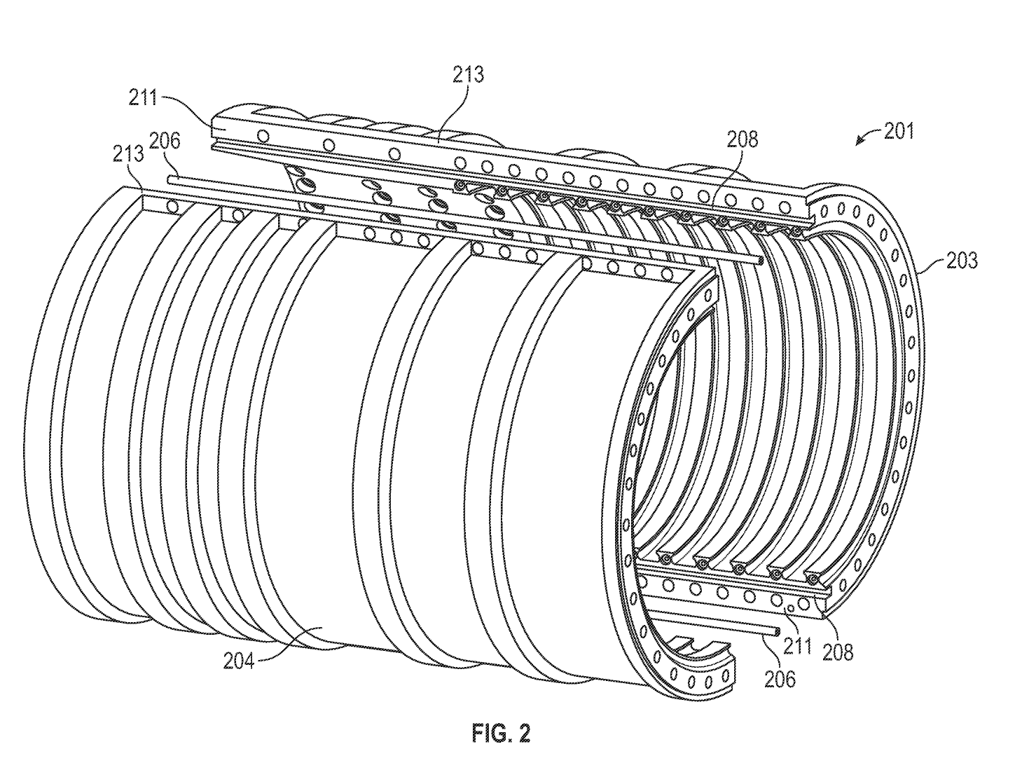

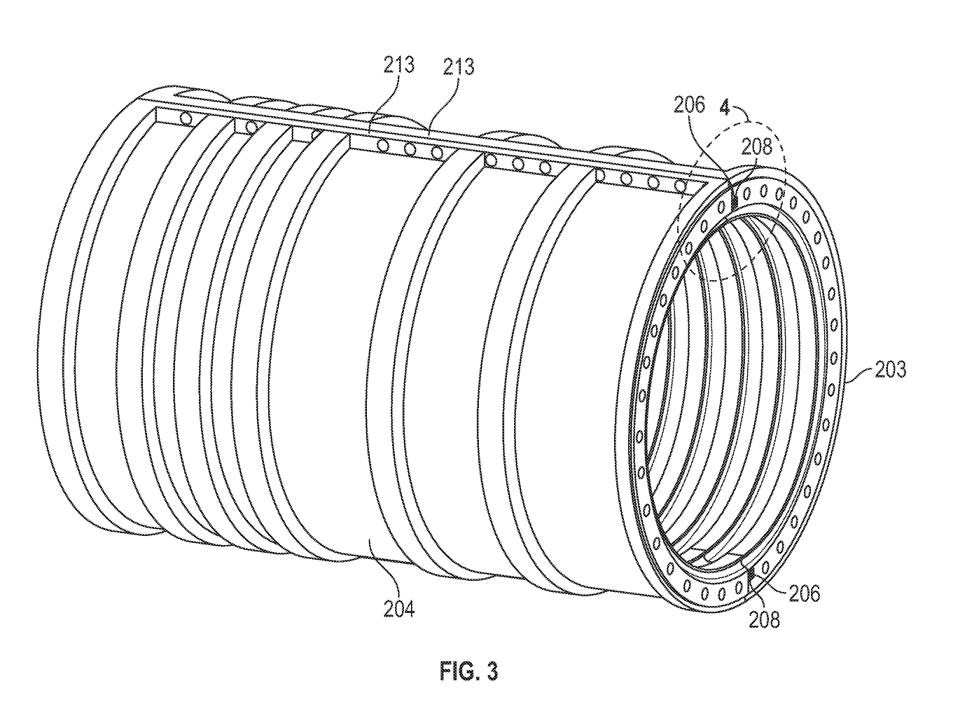

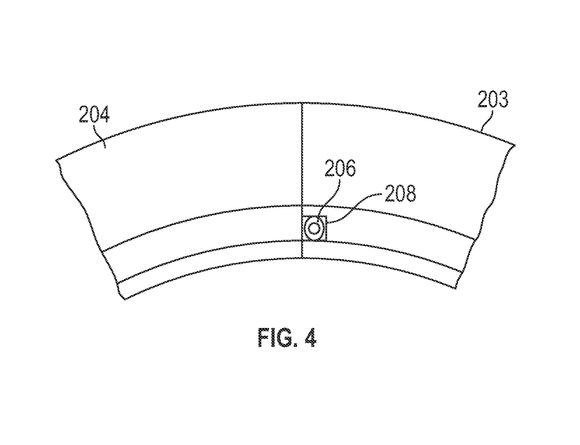

FIG. 2 is an exploded view of aspects of a compressor case 201. FIG. 3 is a corresponding assembled view. FIG. 4 is an end view of an area indicated in FIG. 3. The compressor case 201 may be used as the compressor case 201 of the gas turbine engine 100 of FIG. 1. The illustrated compressor case 201 is created during an overhaul of a previously manufactured gas turbine engine.

The compressor case 201 is split about an axial plane. The compressor case 201 includes a first case segment 203 and a second case segment 204. Each segment is generally half-barrel shaped. The illustrated compressor case 201 has a cross-section that is substantially uniform along the axis of the compressor case 201. Other compressor cases may be tapered or otherwise vary along their axes.

The first case segment 203 and the second case segment 204 are joined at diametrically opposite mating surfaces 211 located along the longitudinal margins of the case segments. The first case segment 203 and the second case segment 204 can be secured together by bolts or other suitable fastening devices through pairs of split flanges 213 that are located along the longitudinal margins of the case segments.

The mating surfaces 211 of the first case segment 203 include grooves 208. The grooves 208 run longitudinally along the mating surfaces 211. The grooves 208 are machined in the mating surfaces 211 during an overhaul of the compressor case 201.

Seal wires 206 are located at the grooves 208. The seal wires 206 are compressed between the mating surfaces 211. The seal wires 206 are malleable and able to fill gaps that may exist between facing areas of the mating surfaces 211.

In the embodiment shown in FIGS. 2-4, the grooves 208 have a rectangular cross-section. Other shapes can also be used.

The grooves 208 in the illustrated embodiment extend the full length of the mating surfaces 211. Other compressor cases may have grooves that extend less than the full length. Additionally, the grooves 208 may be in the mating surfaces 211 of both the first case segment 203 and the second case segment 204 or one of the grooves 208 may be in the first case segment 203 and one of the grooves 208 in the second case segment 204.

In the embodiment shown in FIGS. 2-4, the seal wires 206 are hollow stainless steel wires. The seal wires 206 can also be solid and other materials, for example, copper, can be used. The copper may be annealed.

The dimensions of the grooves 208 and the seal wires 206 are similar. In one implementation, the grooves 208 are 0.060″ wide and 0.050″ deep and the seal wires 206 have a diameter of 0.062″. In another implementation, the grooves 208 are 0.050″ wide and 0.030″ deep and the seal wires 206 have a diameter of 0.040″. It should be understood that the foregoing dimensions are exemplary and the grooves and seal wires can have other dimensions.

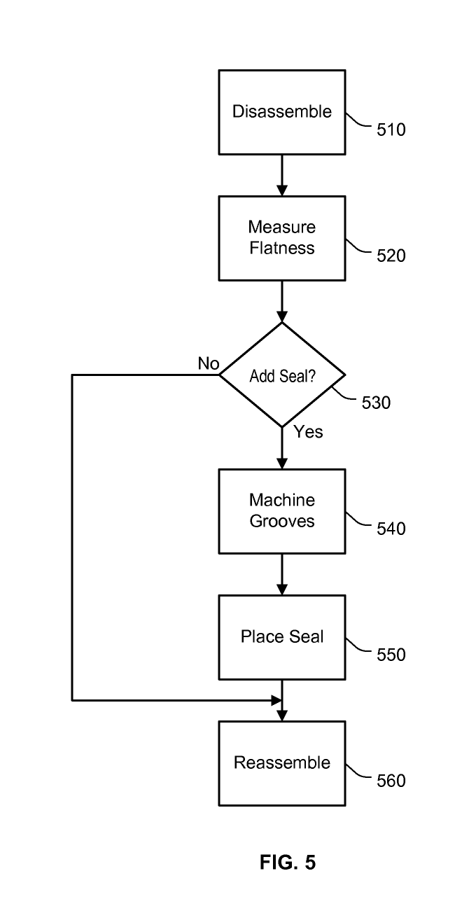

FIG. 5 is a flowchart of a process for overhaul of compressor cases. The process produces the compressor case illustrated in FIGS. 2-4. The process may be performed on the compressor case of a gas turbine engine. The overhaul can be for scheduled or periodic maintenance or for repair of degraded performance or malfunction of the gas turbine engine.

In step 510, the compressor case that is being overhauled is disassembled. The compressor case is split into first and section case segments. Various fixtures may be used during the disassembly. Various methods of disassembly are used depending on how the case segments are fastened together.

In step 520, flatness of the mating surfaces 211 is measured. The flatness may be measured by crushing a plastic gauging material between corresponding pairs of the mating surfaces.

In step 530, the process determines whether the flatness measured in step 520 indicates that seals are to be added to the compressor case. Seals will be added when the compressor case could otherwise leak after reassembly. The determination may be based on a maximum gap between corresponding areas of the mating surfaces, variation in flatness, or some other measurement. If seals are to be added, the process continues to step 540; otherwise, the process continues to step 560.

In step 540, grooves are formed in two of the mating surfaces. The grooves may be located in various positions as described for the compressor case 201 of FIGS. 2-4. The grooves may be formed by a machining process, for example, computer-numerical-controlled milling.

In step 550, seals are placed at the grooves. The seals may be placed by pressing the seals partly into the grooves.

In step 560, the compressor case is reassembled. Reassembly may be substantially the reverse of the disassembly performed in step 510. The compressor case may additionally be tested, for example, to check for leakage.

The process for overhaul of compressor cases may be modified by adding, omitting, reordering, or altering steps. For example, in some embodiments, grooves and seals are added to the overhauled compressor cases without regard to the flatness of the mating surfaces. In such embodiments, step 520 and step 530 are omitted.

### INDUSTRIAL APPLICABILITY

The compressor case 201 of a gas turbine engine segregates an internal high-pressure region from an external low-pressure region. When first manufactured, the mating surfaces 211 of the first case segment 203 and the second case segment 204 are machined to precise tolerances. Metal-to-metal contact between the mating surfaces 211 precludes leakage between the first case segment 203 and the second case segment 204.

Warpage or other distortion of the compressor case 201 can occur during operation of the gas turbine engine. The distortion can leave a gap, resulting in a leak, between facing areas of the mating surfaces 211.

During an overhaul of the gas turbine engine, distortion of the compressor case 201 could be addressed by machining material off the mating surfaces 211. A suitable machining method may be expensive and some compressor cases may be distorted in ways that are not amenable to such machining. Alternatively, a new compressor case could be used.

The present compressor case overhaul uses seal wires 206 located at grooves 208 in the mating surfaces 211. The seal wires 206 are held in position by the grooves 208. The seal wires 206 are compressed by the mating surfaces 211 so that the shape of the seal wires 206 conforms to the shape of the mating surfaces 211. Leakage paths that may exist at gaps between the mating surfaces 211 are blocked by the seal wires 206.

The dimensions of the grooves 208 and the seal wires 206 can be chosen based on how the mating surfaces 211 deviate from flat. The width of the grooves 208 may be slightly less than the diameter of the seal wires 206 so that the seal wires 206 can be pressed into the grooves 208 and retained during assembly of the compressor case 201. The depth of the grooves 208 is less than the diameter of the seal wires 206 so that the seal wires 206 are compressed by the opposite mating surface 211.

The present compressor case overhaul provides an effective seal between case segments and can be performed quickly and economically. The present overhaul may be performed with simpler equipment than would be used to machine the entire mating surfaces of the case segments. Consequently, compressor case overhauls can be performed more quickly and less expensively. The seal wires allow overhaul of compressor cases that might otherwise have been replaced, thereby providing cost savings. The seal wires can also allow overhaul of compressor cases that might otherwise have had an imperfect seal.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular compressor case overhaul, it will be appreciated that compressor cases and overhauls in accordance with this disclosure can be implemented in various other configurations and used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A method for overhaul of a longitudinally-split compressor case, the compressor case comprising two case segments, each of the case segments having a half-barrel section and mating surfaces at the longitudinal margins of the half-barrel section, the case segments being joined at corresponding pairs of the mating surfaces, the method comprising:
machining longitudinal grooves into the mating surfaces of a first one of the case segments;
locating seal wires at the grooves; and
reassembling the compressor case.

2. The method of claim 1, wherein the grooves have a rectilinear cross-section.

3. The method of claim 1, wherein the seal wires are formed of a malleable material.

4. The method of claim 1, wherein the seal wires are stainless steel wires.

5. The method of claim 4, wherein the seal wires are hollow.

6. The method of claim 1, wherein the seal wires are copper wires.

7. The method of claim 1, further comprising determining flatness of the mating surfaces.

8. The method of claim 1, wherein determining the flatness of the mating surfaces comprises crushing a plastic gauging material between corresponding pairs of the mating surfaces.

9. A compressor case for a gas turbine engine, the compressor case comprising:
a first case segment comprising a half-barrel section, mating surfaces at the longitudinal margins of the half-barrel section, and grooves disposed longitudinally in the mating surfaces;
a second case segment comprising a half-barrel section and mating surfaces at the longitudinal margins of the half-barrel section, the first case segment and the second case segment joined at corresponding pairs of the mating surfaces; and
seal wires disposed at the grooves,
wherein the grooves are formed in the mating surfaces of the first case segment during an overhaul of the compressor case.

10. The compressor case of claim 9, wherein the first case segment further comprises flanges extending from the half-barrel section near the longitudinal edges, and wherein the second case segment further comprises flanges extending from the half-barrel section near the longitudinal edges, corresponding pairs of the flanges being used to secure the first case segment to the second case segment.

11. The compressor case of claim 9, wherein the grooves have a rectilinear cross-section.

12. The compressor case of claim 9, wherein the seal wires are formed of a malleable material.

13. The compressor case of claim 9, wherein the seal wires are stainless steel wires.

14. The compressor case of claim 13, wherein the seal wires are hollow.

15. The compressor case of claim 9, wherein the seal wires are copper wires.
